(19) United States
(12) Patent Application Publication
(10) Pub. No.: US 2012/0195714 A1
(43) Pub. Date: Aug. 2, 2012

(54) METHOD FOR FASTENING LOOSE PAPER SHEETS

(75) Inventors: Sebastian Kolasa, Pyskowice (PL); Aleksander Macha, Gliwice (PL); Krystian Nawrat, Gliwice (PL)

(73) Assignee: OPUS SPOLKA Z O. O., Gliwice (PL)

(21) Appl. No.: 13/363,041

(22) Filed: Jan. 31, 2012

(30) Foreign Application Priority Data
Feb. 1, 2011 (PL) P-393811

(51) Int. Cl. B42F 3/06

(52) U.S. Cl. 412/7

(57) ABSTRACT

A method of temporary fastening together a stack of loose paper sheets, in which at least one opening has been formed. The method includes threading at least one connecting element through at least one opening of the sheets in the stack. The connecting element is spiral-shaped, is made of a resilient material, and includes at least one loop.

The present application claims priority to Polish Patent Application No. P-393811, filed Feb. 1, 2011. The entire disclosure of this prior application is incorporated by reference in its entirety herein.

The present invention relates to a method for temporarily fastening loose sheets together without the use of specialized equipment.

There are known methods for fastening loose paper sheets, requiring specialized equipment to fasten the sheets, as well as to unfasten them, such as binding machines. These machines often require that perforations are made in a stack of paper sheets prior to binding, wherein the holes must be precisely made in a repeated way. There are also known methods for fastening loose paper sheets without the use of specialized equipment, but they require complicated fasteners or fasteners that do not allow for a flat unfolding of the fastened sheets.

The present disclosure provides a method for fastening loose paper sheets that does not require specialized equipment nor a complex connecting element. The method also enables a flat unfolding of the fastened stack of sheets, as well as rotation of the sheets to almost 360 degrees.

The sheets in the stack of loose sheets have, close to their edges, at least two openings formed (e.g., by a puncher) through which at least one individual connecting element is manually threaded. Each connecting element is a section of a spiral, consisting of at least one loop, preferably about two loops. Fractional parts of loops are acceptable. Each connecting element is made of a resilient material, which is resistant to a permanent deformation. The ends of both sides of the loops are cut obliquely, and the material properties allow for at least a deflection of one of the ends in an amount that is greater than or equal to a thickness of the stack.

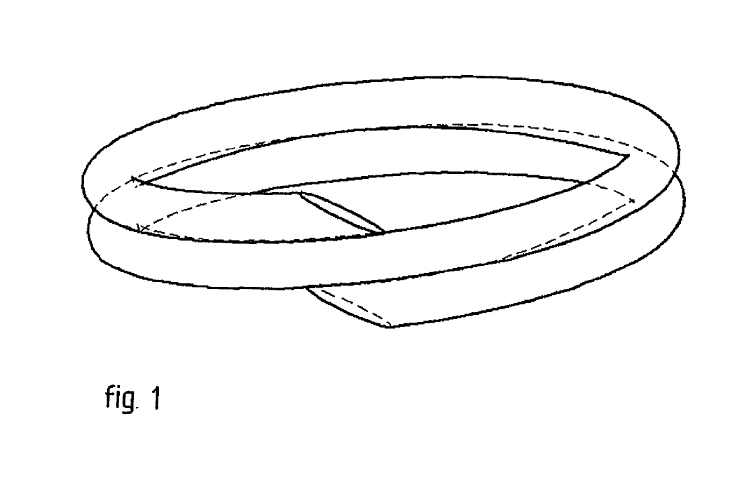

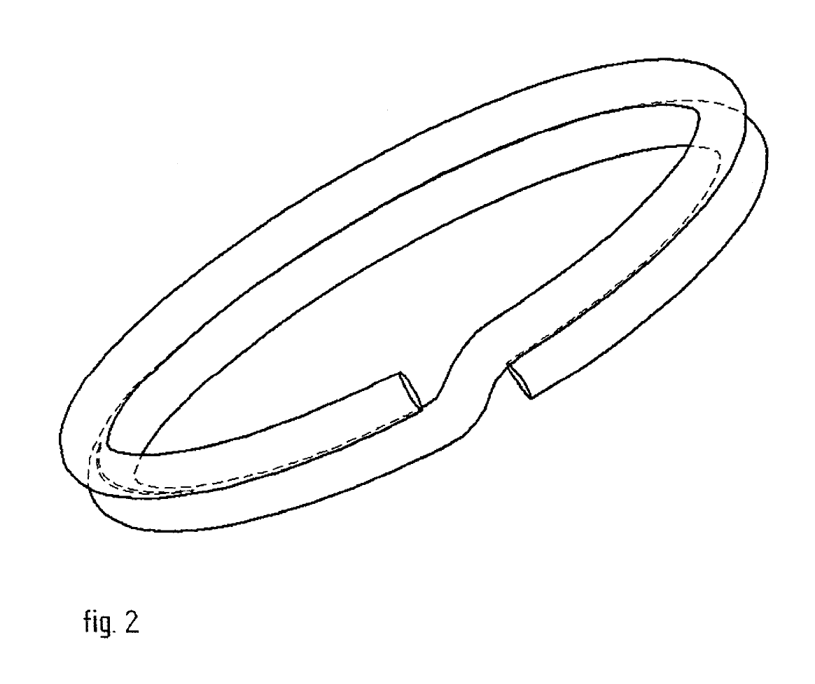

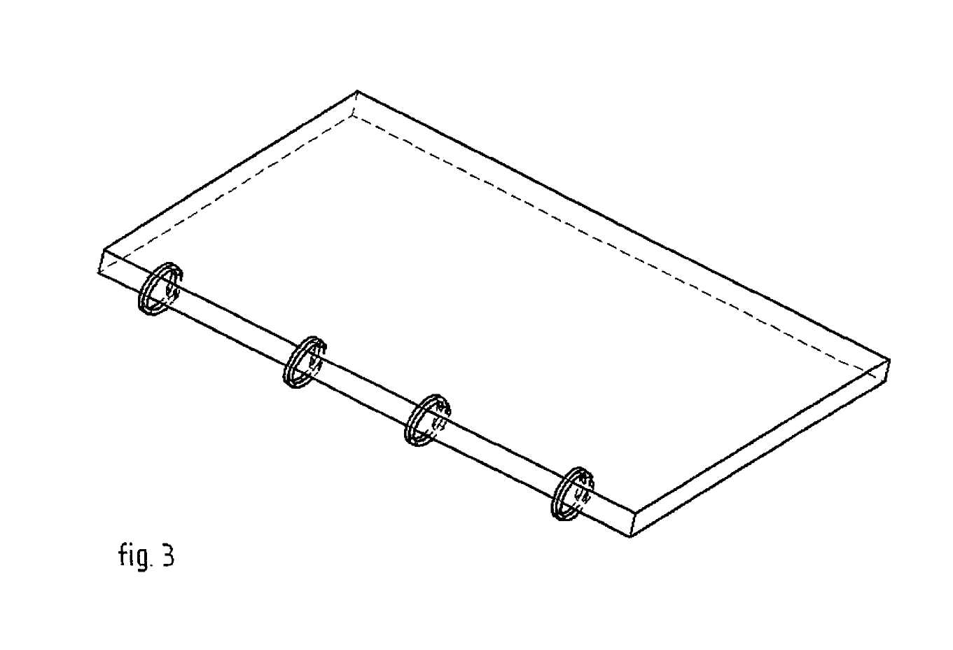

The connecting elements for temporarily fastening loose paper sheets are described more closely using drawings, in which FIG. 1 shows an enlarged connecting element, FIG. 2 shows a variation of the enlarged connecting element, and FIG. 3 shows an example of a document fastened with the connecting element.

The stack of loose paper sheets is punched at an edge with a puncher. Any available holes puncher can be used and the spacing between the holes need not be equal. The connecting element is a section of a spiral comprising at least one loop, preferably about two loops, fractional parts of the loop can be used. Distances of the holes from the edges of paper sheets cannot be larger than the inner radius of the loop. The number of loop turns is adjusted to the thickness of the stack so that easy turning of sheets is obtained without blocking, and the threading of the connecting element through the holes is not too long. Increasing the number of loops results in a significant strengthening of the binding. The ends of the loop can be beveled for easy insertion into the holes and for obtaining restriction-free turning of the sheets, as shown in FIG. 1, or at least one of the ends of the loop may be bluntly terminated, and an inflection (i.e., bend) may be formed in the loop near the bluntly terminated end (or ends), as shown in FIG. 2. Elasticity of the material from which the connecting element is made preferably allows for a deflection of one end of the loop in an amount that is greater than or equal to the thickness of the stack.

The materials that can be used to form the connecting elements are preferably deformable (permanent set or plastic strain) at temperatures above 70° C. At room temperature (about 20° C. to about 25° C.), the materials preferably have strong elastic properties and are inextensible. For example, such materials preferably have a breaking elongation that is at least 20%, a tensile strength that is at least 45 MPa, and a Rockwell strength (hardness) that is at least 80 HRR.

Furthermore, the materials are preferably aesthetically pleasing and pleasant to the touch. The ends of the connecting elements preferably do not pose a threat of an injury. Additionally, the thickness of the materials is preferably from about 28% to 37%, more preferably from 30% to 35%, yet more preferably about 1/3 (one third) of the diameter of the openings in the fastened paper sheets.

Various plastics are among the materials that can be used to form the connecting elements. For instance, polyvinyl chloride (PVC) plastics can be used. A PVC plastic filament wire is a non-limiting example of such PVC plastics. Table 1 shows the preferable properties of a PVC plastic filament wire.

TABLE 1
PVC PLASTIC FILAMENT WIRE PARAMETER

| | |
|---|---|
| Material | PVC |
| Breaking Elongation | ≧20% |
| Tensile Strength | ≧45 Mpa |
| Rockwell Strength | ≧80 HRR |

Plastic Filament Wire Tension

| Filament Diameter | Breaking Tension |
|---|---|
| 0.050″(1.27 mm) | 13 LBS |
| 0.062″(1.57 mm) | 17 LBS |
| 0.064″(1.62 mm) | 19 LBS |
| 0.070″(1.78 mm) | 26 LBS |
| 0.075″(1.91 mm) | 29 LBS |
| 0.090″(2.28 mm) | 40 LBS |
| 0.110″(2.794 mm | 56 LBS |

The stack of loose paper sheets can be fastened with the one or more connecting element by manually threading the one or more connecting element through the holes. The holes in the stack do not necessarily have to be formed at a uniform or regular spacing. The binding of stacks of loose paper sheets is achieved in an easy way and with available tools. Additionally, the binding of the stack is convenient, it can be possible to easily turn pages, the connecting elements can be easy to remove, and it is possible to rotate the sheets to about 360 degrees.

1. A method of temporarily fastening together a stack of two or more loose paper sheets, the sheets including at least one opening formed therethrough, the method comprising:
threading at least one connecting element through the at least one opening of the sheets in the stack, the at least one connecting element being spiral-shaped, being made of a resilient material, and including at least one loop.

2. The method according to claim 1, further comprising forming the at least one opening in each sheet in the stack.

3. The method according to claim 2, wherein the at least one opening in the sheets in the stack is formed using a puncher.

4. The method according to claim 1, wherein the at least one opening is formed proximal to an edge of the sheets in the stack.

5. The method according to claim 1, wherein the at least one connecting element is resilient to a permanent deformation.

6. The method according to claim 1, wherein the at least one connecting element includes a fractional part of a loop.

7. The method according to claim 1, wherein an end of the at least one connecting element is capable of a deflection that is greater than or equal to a thickness of the stack.

8. The method according to claim 1, wherein at least two holes are formed proximal to an edge of the sheets in the stack, and at least two connecting elements are threaded through the at least two holes.

9. The method according to claim 1, wherein at least one end of the at least one loop of the at least one connecting element is beveled.

10. The method according to claim 1, wherein at least one end of the at least one loop of the at least one connecting element is bluntly terminated, and at least one inflection is formed in the at least one loop.
